(19) United States
(12) Patent Application Publication
(10) Pub. No.: US 2025/0206420 A1
(43) Pub. Date: Jun. 26, 2025

(54) MARINE STRUCTURE AND METHOD

(71) Applicants: Monobase Wind B.V., Edam (NL); Daewoo Engineering & Construction Co., Ltd., Seoul (KR)

(72) Inventors: Herm Berend Bussemaker, Purmerend (NL); Kyung Tae Bae, Seoul (KR)

(21) Appl. No.: 18/844,132

(22) PCT Filed: Mar. 9, 2023
(86) PCT No.: PCT/EP2023/056050

§ 371 Date: Sep. 5, 2024

(30) Foreign Application Priority Data
Mar. 9, 2022 (NL) 2031193

(51) Int. Cl. B63B 77/10; B63B 21/20; B63B 21/50; B63B 35/44

(52) U.S. Cl. CPC B63B 77/10; B63B 21/20; B63B 21/502; B63B 35/44; B63B 2035/446

(57) ABSTRACT

A marine structure includes a jacket-structure including at least one float element having a first buoyancy, and a linear guide sleeve; a sub-structure including a counterweight structure having a second buoyancy and a leg extending through the guide sleeve, the leg having a lower end connected to the counterweight structure and having an upper end provided with a stop element, where the leg is movable through the corresponding guide sleeve between a towing position, where the stop element is remote from the guide sleeve and where the guide sleeve allows linear motion of the at least one leg with respect to the support structure, and an operating position, where the stop element engages a corresponding counter element of the guide sleeve and wherein the at least one leg is fixated with respect to the at least one guide sleeve.

### CROSS-REFERENCE TO RELATED APPLICATIONS

This application is the National Stage of International Application No. PCT/EP2023/056050, filed Mar. 9, 2023, which claims the benefit of Netherlands Application No. 2031193, filed Mar. 9, 2022, the contents of which is incorporated by reference herein.

### FIELD OF THE INVENTION

The present invention relates to a floating marine structure and a method of installing a floating marine structure. The marine structure may be a base for, for example, a wind turbine.

### BACKGROUND OF THE INVENTION

Traditionally, offshore wind turbines are installed on foundations based on the sea floor in relatively shallow water. A water depth of 40 to 50 m is normally considered the limit for such gravity based foundations arranged on the sea floor.

DE2457536 discloses a marine structure with a floating base, a separate floater and a work deck where the base and floater are lowered to the sea floor to form a foundation using a winch or crane system.

U.S. Pat. No. 4,451,174 discloses a platform comprising a foot structure having a plurality of watertight compartments which are controllably ballastable with sea water between an unballasted buoyant state which allows floating of the platform during transit and a ballasted state while stationary at the use site. The foot structure rigidly supports a single central column extending through a central opening of a deck which is movably supported on the column. The deck carries a plurality of jack-up legs to move the deck relative to the foot structure along the column. During transit of this mobile offshore platform, the deck is lowered to a position adjacent to the foot structure with the platform floating on the foot structure alone. During installation of the platform, the buoyancy of the deck will be used to provide stability and buoyancy. The base is lowered or pushed down to the sea bottom using a winch or crane system to form a gravity-based foundation.

U.S. Pat. No. 4,627,767 discloses a marine structure with a base, a separate floater and a deck structure where the base is ballasted down to the sea bottom and where the separate floater is used to provide stability during lowering and being connected to the base and deck using a winch or crane system to form jacking legs.

WO2010/085970 discloses a marine structure with a base, a separate floater and a deck structure where the base is ballasted down to the sea bottom and where the separate floater is used to provide stability during lowering and being connected to the base and deck using a winch or crane system to form jacking legs.

A drawback of the marine structures described above is that the different buoyancy elements to provide buoyancy and stability during lowering of the base are connected or need to be connected in vertical sense with a lifting or jacking system. The effect of this connection will be that all elements will show the same wave induced heave motions which reduce the capability to withstand wave-induced forces and motions during installation. Also the system will introduce large dynamic loads due to wave actions and requires additional costs to install and procure the lift system. Another drawback of the marine structure is that the marine structure is relatively unstable when sinking the base to the sea floor. Temporary buoyancy means, i.e. buoyancy means which are detached from the marine structure after installation, may be provided to increase stability during installation. However, the provision of temporarily means involves extra steps during installation, increasing costs.

In many areas of the world however, there is simply not enough offshore area available with suitable water depths of—for instance—at most 50 m, for deployment of offshore wind power to the desired extent. Here, alternatives may be required, such as floating foundations for wind turbines.

A variety of different floating foundation concepts are possible for use offshore, conventionally used by the oil industry and potentially also suitable for wind turbines. The three primary concepts are spar buoys, semisubmersibles and Tension Leg Platforms (TLPs). Each of these primary concepts has its advantages and limitations.

A spar buoy maintains stability from a deep draft combined with ballast. It is the simplest floating foundation concept, typically consisting of a simple air-filled, floating tube which is kept vertical in the water by ballasting at the bottom. Suitably dimensioned, a spar buoy can support the weight and loads from a large wind turbine while maintaining a near-vertical position. Typically, the function of the mooring lines is only to maintain position and preventing drifting. Some spar buoy designs seek to achieve additional benefits from taut mooring lines; these designs have not yet been tested in practice. The simplicity of the spar buoy concept makes it inherently attractive.

However, the draft poses major challenges during the installation and transportation phases. Due to the motion of the sea it is generally not considered feasible to install wind turbines on floating foundations under ocean conditions at their final location, and therefore floating wind turbines are normally installed at quayside using land-based cranes, or in sheltered waters using floating cranes. Spar buoys generally have drafts larger than 50 m, some designs even have drafts larger than 100 m, and this effectively prevents quayside wind turbine installation using land-based cranes. Therefore, wind turbines are normally installed on spar buoy floating foundations in sheltered waters, such as deep fjords, using floating cranes.

While it is fairly easy in a few countries, such as Norway, to find sheltered waters with sufficient depth to permit wind turbine installation using a floating crane, in many parts of the world such sheltered waters with sufficient depth are not available. Furthermore, even where such sheltered waters with sufficient depth are available, the presence of ridges or shoals in the transportation corridor between the point of installation and the desired offshore locations will often effectively prevent the utilization of such sheltered waters for turbine installation. These limitations caused by the deep draft of a spar pose a significant problem for the spar buoy concept.

One solution for turbine installation with spar buoy floaters is to install the turbine while the spar buoy is in an inclined position, for instance in an almost horizontal position. WO2010/018359 discloses an installation method based on such near-horizontal orientation of the spar buoy. Here, the near-horizontal position is maintained through the attachment of a temporary buoyancy device connected to the bottom of the spar buoy. With this arrangement the turbine can be installed at quayside in the near-horizontal position using land-based cranes. After towing to the desired offshore location, the spar buoy is brought to its final, vertical position through gradual disengagement of the temporary buoyancy device.

WO2013/048257 discloses another installation method based on near-horizontal orientation of the spar buoy. Here, the near-horizontal position is maintained through the connection of the spar buoy to a supplementary buoyancy device, where the connection is arrangement with a rotary coupling device which permits the change of the orientation of the spar buoy and the wind turbine mounted on the spar buoy. The orientation can be changed from near-horizontal during turbine installation and towing to the desired location. After towing to the desired offshore location, the spar buoy can be brought to its final, vertical position through rotation of the rotary coupling.

Methods like those disclosed in WO2010/018359 and WO2013/048257 inherently assume that a wind turbine can be placed in a near-horizontal orientation. However, this is generally impossible for wind turbines exceeding a certain size. Significant parts of the equipment used in wind turbines, e.g. controller enclosures, transformers, etc. are suited for normal, vertical orientation only. In addition, some of the structural components will need to be of larger dimensions to accommodate the gravity loads when tilted. Lubricants, coolants and other fluids pose a special problem; seals in bearings, gearboxes, hydraulics, expansion tanks, will need to be of special design to allow for near-horizontal orientation. Given that the industry is moving to ever larger turbines, often exceeding 100 m height, these spar buoy installation methods are virtually unsuitable.

A semisubmersible floating foundation obtains stability from a large waterplane area at a moderate draft, in combination with ballast which ensures a relatively low centre of gravity. The semisubmersible concept is not as simple as the spar buoy concept, but it has the advantage of shallow draft. The shallow draft allows turbine installation at quayside using land-based cranes, and it allows towing to an offshore location. The semisubmersible concept typically includes mooring lines to maintain position and preventing drifting. The relative simplicity of the semisubmersible concept makes it inherently attractive. However, the stability is a concern. Considerable heel can be experienced during turbine operation due to the relatively large lateral forces acting on the turbine rotor.

WO2009/131826 discloses an arrangement whereby the heeling angle during turbine operation can be reduced with a ballast control system. The floating foundation is fitted with a set of pumps and valves that is used to redistribute water ballast between the three main columns comprising the stabilizing body of the foundation. Through redistribution of water ballast the overturning moment created by the large lateral forces acting on the turbine rotor can be offset by an overturning moment in the opposite direction created by the moveable ballast. The arrangement disclosed in WO2009/131826 has obvious disadvantages. Firstly, through the introduction of active sensor and pumping systems a new level of complexity is introduced, inherently violating the fundamental principle that due to the challenges in accessibility unmanned offshore structures should have as few active systems as possible. Secondly, since the masses that need to be redistributed are significant, measured in hundreds or thousands of tons, the balancing system will be semi-static, typically with time constants on the order of minutes even when very large pumps are used. Consequently, transient changes in the overturning moment created by the large lateral forces acting on the turbine rotor cannot be balanced.

U.S. Pat. No. 8,118,538 discloses an alternative way of reducing the heeling angle during turbine operation due to the overturning moment created by the large lateral forces acting on the turbine rotor. A counterweight is mounted some way below the floating platform, and it essentially acts as a keel. In further embodiments the counterweight is connected to adjustable anchor lines and also serves to tighten these lines.

Thus, both the spar system and the semisubmersible system pose challenges.

WO2017157399 proposes a floating wind turbine comprising a hull, a wind turbine mounted on top of the hull and a counterweight suspended below the hull by means of counterweight suspension means. A method for the installation of a floating wind turbine comprising the hull, and a wind turbine mounted on top of the hull and a counterweight suspended below the hull by means of counterweight suspension means is also disclosed. The static and dynamic response of the floating foundation can be adjusted before installation through a combination of adjustment of i) ballasting of the counterweight buoyancy tanks, ii) ballasting of the hull, and/or iii) adjustment of the installed depth of the counterweight.

Disadvantage of the method and floating wind turbine of WO2017157399 relates to the suspension means. The counterweight requires multiple wires or cables to stabilize the counterweight, to keep the weight in position and to prevent or limit torsion. Offshore, said wires or cables will typically result in increased maintenance requirements and unplanned outage. For a relatively low-margin operation such as individual wind turbines, the maintenance and unplanned outage results in prohibitive operating costs rendering the structure economically unviable.

U.S. Pat. No. 9,499,240B2 discloses a floating marine structure comprising: a sub-structure having only one leg having at least one first buoyancy chamber arranged in a lower part of the leg to provide a first buoyancy, wherein the first buoyancy is sufficient to keep the sub-structure afloat, and wherein the at least one first buoyancy chamber is ballastable to decrease buoyancy of the leg; and a float element having at least one second buoyancy chamber to provide a second buoyancy, wherein the second buoyancy is sufficient to keep the float element afloat, and wherein the at least one second buoyancy chamber is ballastable to decrease buoyancy of the float element, wherein the float element comprises a substantially vertically orientated passage extending through the float element and enclosing the leg in a substantially horizontal plane to form a linear guide to guide linear movement of the float element with respect to the sub-structure in the substantially vertical direction to allow relative wave induced motion with respect to each other in a substantially vertical direction, wherein the leg is movable from a pre-installation position to an installation position by a substantially downwards movement of the leg with respect to the float element, wherein during at least a second part of the downwards movement of the leg towards the installation position and/or in the installation position the at least one first buoyancy chamber is substantially located below a wave zone to substantially decrease heave action on the at least one first buoyancy chamber, and wherein during the at least a second part of the downwards movement of the leg, the weight of the complete sub-structure is carried by the leg.

The structure and method of U.S. Pat. No. 9,499,240B2 are focused on, and optimized for gravity based application.

WO 2018/150064 discloses a floating spar structure for large offshore wind turbines, formed by a lower triangular caisson made of reinforced concrete and by an upper triangular caisson made of metal on which the shaft of the wind turbine is supported both joined by means of three liftable columns disposed in the corners thereof. The structure is a spar platform because its operation is based on the descent of the centre of gravity of the assembly, but the platform also has semi-submersible components, since it has three floats on the waterline level that increase the restoring moment thereof.

Disadvantage of the method and floating wind turbine of WO 2018/150064 relates to the semi-submersible component embodied by the floats in the waterline to improve the restoring moment. The envisaged floats in the waterline will attract wave loading, leading to excessive motions and accelerations, that will downgrade the performance of the wind turbine. Also, the system included in the upper triangular caisson for guiding the legs transfers the load of each leg in a radial direction by direct compression against the leg. This will result in relatively large local stresses in the respective leg, which in turn will greatly reduce the capacity of the system.

WO 2013/083358 discloses a floating wind power plant comprising a buoyancy body configured for being submerged in water and supporting an equipment unit extending above water, and a ballast element connected to the buoyancy body via at least one spacer structure. Guiding means in the buoyancy body are configured for movable interaction with the at least one spacer structure such that the ballast element and the buoyancy body are movable with respect to one another. The buoyancy body has an elongated shape with a forward portion and an aft portion, and the ballast element has a corresponding forward portion and an aft portion.

The buoyancy body and spacer structure of WO 2013/083358 are relatively bulky and as a result require significant amounts of structural material, such as steel and concrete, rendering the structure relatively complex and capital intensive.

It is an aim of the present invention to provide an alternative floating marine structure obviating at least one or more of the disadvantages of the prior art.

### SUMMARY OF THE INVENTION

Aspects of the present invention are set out in the accompanying description.

The disclosure provides a marine structure, comprising:
a jacket-structure for supporting a functional element in a body of water, the jacket-structure comprising at least one float element having a first buoyancy, and at least one linear guide sleeve;
a sub-structure comprising a counterweight structure having a second buoyancy and at least one leg extending through the at least one guide sleeve, the at least one leg having a lower end connected to the counterweight structure and having an upper end provided with a stop element,
wherein the at least one leg is movable through the corresponding guide sleeve between a towing position, wherein the stop element is remote from the guide sleeve and wherein the guide sleeve allows linear motion of the at least one leg with respect to the support structure, and an operating position, wherein the stop element engages a corresponding counter element of the guide sleeve and wherein the at least one leg is fixated with respect to the at least one guide sleeve.

In an embodiment, the jacket-structure comprising a fixating mechanism to fixate the at least one leg with respect to the support structure when in the operating position.

In an embodiment, the fixating mechanism comprising one or more sets of wedges, one wedge part of each set of wedges being connected to an outer surface of the at least one leg, and a second wedge part of each set of wedges being connected to an inner surface of a corresponding guide sleeve.

In an embodiment, the marine structure comprises a linear guiding system, integrated in the at least one guide sleeve. The linear guiding system may comprise ridges distributed along the circumference of the at least one guide sleeve, and corresponding nooks fitting between two ridges and extending from an outer surface of the at least one leg.

In an embodiment, the counterweight structure has an adjustable weight, said weight providing buoyancy when in the towing position and said weight weighing the marine structure down when in the operating position.

In an embodiment, the functional element includes a wind turbine.

In an embodiment, the counterweight structure encloses the lower end of the at least one leg.

In an embodiment, the at least one guide sleeve is provided with a brake to limit movement of the at least one leg with respect to the corresponding at least one guide sleeve.

In an embodiment, the marine structure comprises multiple legs, each leg being enclosed by the at least one float element.

In an embodiment, the first buoyancy exceeds a gravitational force of the rest of the marine structure including the weighed counterweight structure when in the operating position, keeping the marine structure afloat.

In an embodiment, the marine structure comprises at least one thruster for positioning the marine structure in the water.

In an embodiment, the counterweight structure being provided with a first valve for passage of water, and a second valve connected to a pump for pumping gas in or out of the counterweight structure.

In an embodiment, the pump is located above the water surface and being connected to the second valve via a conduit allowing to pump air into or out of the counterweight structure.

In an embodiment, the pump and the conduit are removable to allow removal of the pump and conduit when the marine structure is in the operating position.

According to another aspect, the disclosure provides a method to install a marine structure, the method comprising the steps of:
providing a marine structure comprising:
a jacket-structure for supporting a functional element in a body of water, the support structure comprising at least one float element having a first buoyancy, and at least one linear guide sleeve;
a sub-structure comprising a counterweight structure having a second buoyancy and at least one leg extending through the at least one guide sleeve, the at least one leg having a lower end connected to the counterweight structure and having an upper end provided with a stop element,
wherein the at least one leg is movable through the corresponding guide sleeve between a towing position, wherein the stop element is remote from the guide sleeve and wherein the guide sleeve allows linear motion of the at least one leg with respect to the support structure, and an operating position, wherein the stop element engages a corresponding counter element of the guide sleeve and wherein the at least one leg is fixated with respect to the at least one guide sleeve,
the method comprising the steps of:
moving the at least one leg to the towing position by decreasing the weight of the counterweight structure,
moving the marine structure to an assembly position near shore,
arranging the structural element on the support structure,
towing the marine structure to a predetermined offshore location, and
increasing the weight of the counterweight structure, thereby moving the at least one leg downward to the operating position until the stop element engages the corresponding counter element of the at least one guide sleeve and submerging the at least one float element, and
fixating the at least one leg with respect to the at least one guide sleeve.

In an embodiment, the method comprises the step of anchoring the floating marine structure to the bottom of the body of water using one or more anchoring lines.

In an embodiment, in the operating position the counterweight structure floats below a wave zone.

In an embodiment, in the operating position, the weight of the counterweight structure is increased to submerge the at least one float element.

In an embodiment, the float element is submerged at least below an average wave height at the predetermined offshore location. In a preferred embodiment, in an operating condition, the float element is entirely submerged.

Reducing wave loads on the structure provides a significant advantage of the spar type structure of the disclosure. A balance between restoring moment and relatively low wave loading is achieved by positioning the one or more float elements in the operating condition below the governing wave zone. The restoring moment is achieved by the counterweight structure, which sets the Centre of Gravity of the system well below the Centre of Buoyancy of the system, resulting in the required restoring moment.

In an embodiment, the steps of increasing the weight of the counterweight structure comprises flooding at least one buoyancy chamber in the counterweight structure using a first valve for passage of water, and a second valve connected to a pump for pumping gas into or out of the counterweight structure. The step of flooding the at least one buoyancy chamber in the counterweight structure may comprise controlling a pressure differential over walls of the counterweight structure to remain within a predetermined range. The predetermined range may be +/−1 bar, more preferably +/−0.5 bar.

By controlling the pressure difference during the lowering of the counterweight structure, the required amount of strong, or structural, material can be reduced. The cost reduction due to reduction in the amount of material outweighs the cost of the pressure balancing system. A further advantage is the reusability of the pressure balance system components, which greatly reduces the cost of projects with more than one system to be installed. Typical numbers of systems per project is in the range of 10 to 60 systems. A project herein typically relates to wind farms.

### BRIEF DESCRIPTION OF THE DRAWINGS

Reference will be made to the figures on the accompanying drawings. The figures are schematic in nature and may not necessarily be drawn to scale. Similar reference numerals denote similar parts. On the attached drawing sheets:

FIG. 1A shows a schematic side view of an embodiment of a marine structure according to the present disclosure;

FIG. 1B shows a schematic top view of the embodiment of FIG. 1A;

FIG. 1C shows a side view of the embodiment of FIG. 1B along line A-A;

FIG. 1D shows a side view of the embodiment of FIG. 1B along line B-B;

FIGS. 2A and 2B show a schematic side view along line A-A and B-B respectively (see FIG. 1B) of another embodiment of a marine structure according to the disclosure;

FIG. 3A shows a cross-sectional side view of a fixating mechanism in an disengaged position;

FIG. 3B shows a cross-sectional side view of the fixating mechanism of FIG. 7A in an engaged position;

FIGS. 4A and 4B show a cross-sectional top view of respective embodiments of a linear guiding mechanism of the marine structure of the present disclosure;

FIGS. 5A to 5E show schematic side views of a marine structure, the Figures exemplifying consecutive steps of an embodiment of a method for arranging the floating marine structure;

FIG. 5F shows a perspective view of an embodiment of the floating marine structure in the operating position;

FIG. 6 shows a side view of yet another embodiment of a marine structure according to the disclosure; and

FIGS. 7A to 7C show respective steps of an embodiment of a method of arranging the marine structure of FIG. 6.

### DETAILED DESCRIPTION

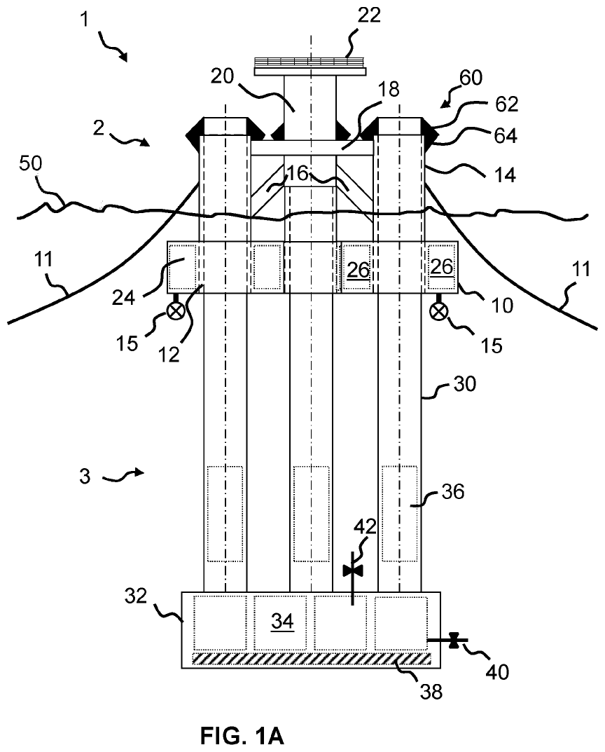

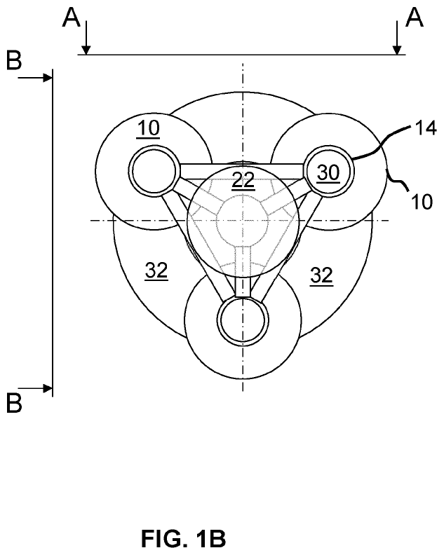

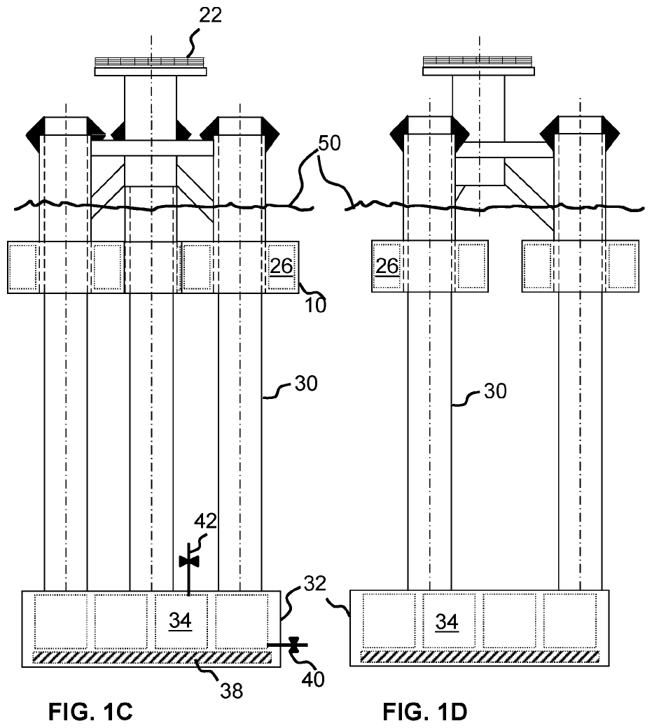

FIG. 1 shows an embodiment of a marine structure 1 according to the present disclosure. The marine structure 1 comprises a support structure 2 and a sub-structure 3.

The support structure 2 comprises one or more float elements 10. The support structure 2 may be referred to as jacket-structure. The one or more float elements 10 are provided with one or more openings 12. The openings 12 may extend into, or be an integral part of, guide sleeves 14. The guide sleeves 14 may extend a predetermined distance above the one or more float elements 10.

The jacket-structure may comprise a number of structural elements 16, 18, 20 to connect the one or more float elements 10 to a main deck 22. The main deck 22 allows to attach a topside structure. The topside structure may be a wind turbine. The structural elements 16, 18, 20 may be, for instance, beams or tubes. The structural elements 16 to 20 may typically be made of a metal, typically steel, of a quality able to withstand corrosion and to provide structural strength as required. Structural elements 16 be diagonal, extending between the tube 20 and one of the sleeves 14. Elements 18 may be arranged in horizontal direction, connecting respective sleeves 14.

The at least one float element 10 of the jacket-structure 2 may be provided with first buoyancy means 24. The buoyancy means 24 may comprise one or more chambers 26. The chambers 24 can be filled with air or water, allowing to adjust the first buoyancy provided by the at least one float element 10. The first buoyancy provided by the at least one float element 10 is typically sufficient to keep at least the jacket-structure 2 afloat. The first buoyancy chambers 24 can be ballasted, for instance by introduction of water, concrete or other material, to decrease the first buoyancy to a required level to control the draft of the jacket-structure 2.

Referring to FIG. 1B, the at least one float element 10 may comprise multiple float elements. For instance, each sleeve 14 may be connected to, or provided with, a separate float element 10. The float elements may have any suitable shape of form. As shown in FIG. 1B, float elements 10 may be circular in top view, having a cylindrical shape. The buoyancy chambers 26 in the float elements may be cylindrical as well. The float elements 10 may be constructed from a suitable material, such as steel or concrete.

The sub-structure 3 comprises one or more legs 30. The sub-structure may comprise, for instance, one, two, three or four legs. The legs are typically tubular and rigid. Lower ends of the legs 30 may be connected to a counterweight structure 32. Upper ends of the at least one leg 30 extend through the openings 12 and the sleeves 14.

The sub-structure 3 may have an adjustable weight or adjustable buoyancy. Herein, the sub-structure 3 may comprise second buoyancy means. The second buoyancy means may comprise one or more chambers 34, 36 allowing to be filled with, typically, air, water, or another suitable material. First chambers 34 may be comprised in the counterweight structure 32. Optionally, second chambers 36 may be included in one or more of the legs 30, typically at or near the lower ends thereof.

As shown in FIG. 1A, the counterweight structure 32 may be a barge-like structure. The counterweight may be, for instance, square or round in top view (see FIG. 1B). The counterweight 32 may enclose all of the legs 30, as shown in FIG. 1A. The counterweight may be elongate in side view, see FIG. 1A. The counterweight may comprise at least one weight element 38. The weight element may be a slab of concrete or similar relatively heavy and dense material. The counterweight structure 32 may be fabricated using concrete and/or steel, for instance steel reinforced concrete.

In a practical embodiment, the counterweight structure may be substantially round, provided with a central moonpool or opening. The counterweight may have a doughnut shape. The one or more legs 30 may be substantially round. The legs may be connected to a top side of the counterweight structure.

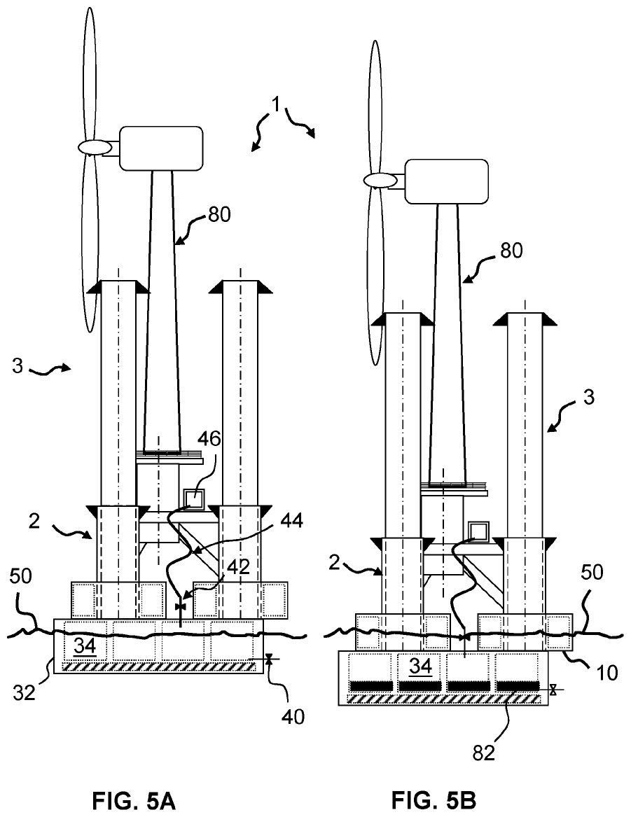

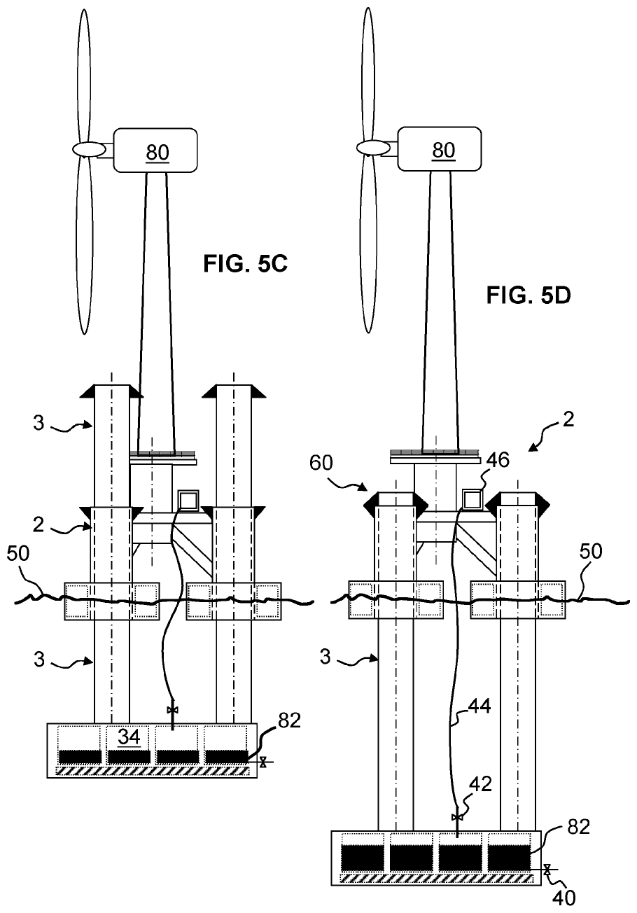

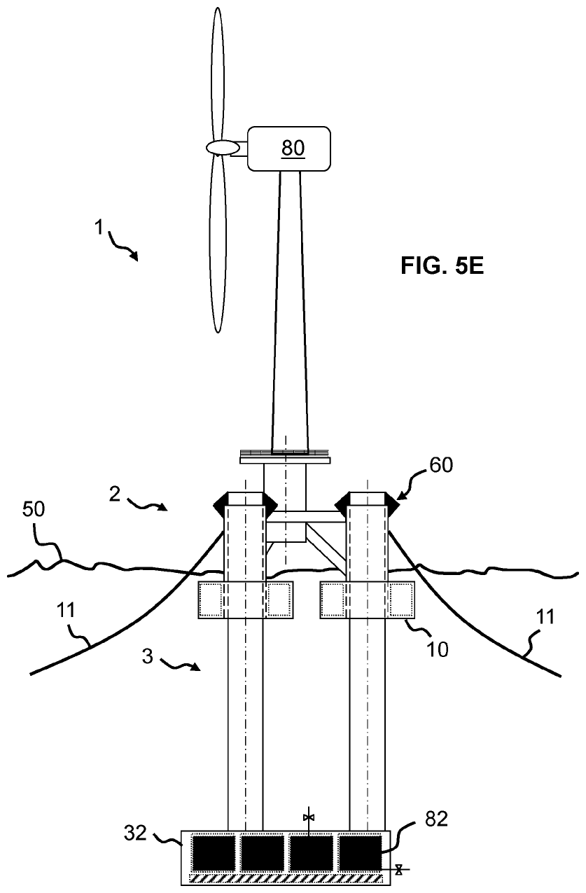

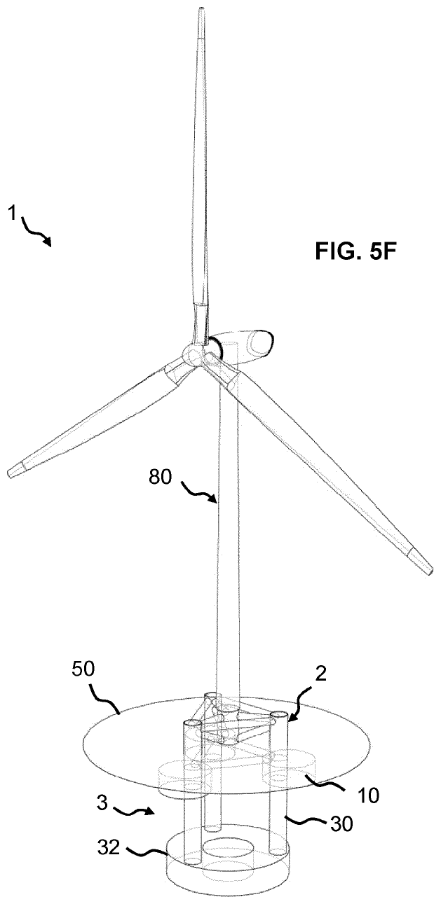

The air chambers 34, 36 allow to provide and adjust the buoyancy of the sub-structure 3. The buoyancy of the sub-structure 3 may be referred to herein as second buoyancy. In an embodiment, the air chambers 34, 36 of the sub-structure 3 may be connected to a first valve 40 and a second valve 42. The first valve 40 may connect one or more of the chambers 34, 36 to the environment, typically a body of water 50, such as the sea or ocean, wherein the marine structure will be positioned for operation. As shown in, for instance, FIG. 5A, the second valve 42 may be connected via a suitable conduit 44 to a control unit and/or pump 46 located above the surface of the water 50. The conduit 44 may be a flexible hose of a suitable material, typically comprising rubber or a similar elastomer. The pump 46 and hose 44 may be removably connected to the valve 42, allowing to remove the hose and pump once the marine structure 1 has been positioned in a predetermined offshore location and is in its operation position. Transition from an assembly position, allowing towing of the structure, to the operating position, will be described herein below. Removal of pump and hose allows to save costs on pump units, while allowing relatively accurate control of the buoyancy of the counterweight 32. The latter allows accurate control of upward and downward movement of the counterweight 32 in the water 50. The control of the buoyancy is for instance significantly more accurate than prior art systems, wherein an air inlet to buoyancy chambers of the sub-structure herein is connected to the environment via the legs, without valves or control mechanisms.

When filled with air, the positive buoyancy provided by the combination of the chambers 34, 36 may be sufficient to keep the marine structure 1 afloat. This allows the entire structure 1 to float on the counterweight structure 32 in the transport phase, see for instance FIG. 5A. Herein, the counterweight structure 32 may act and behave as a barge. The second buoyancy means 34, 36 can be ballasted, for instance by replacing air with a heavier material such as water, concrete or another material. The increasing weight and correspondingly decreasing second buoyancy can be accurately controlled, to a level wherein the sub-structure 3 starts to sink. Herein, the counterweight 32 will have negative buoyancy and will function as a counterweight.

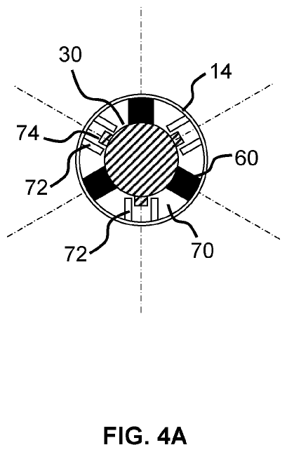

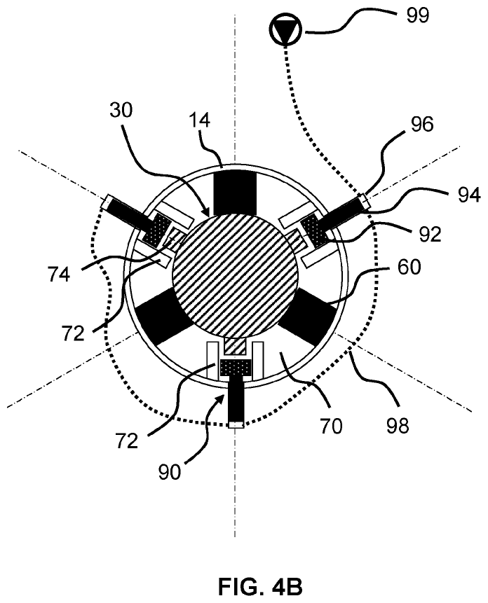

The guide sleeves 14 are provided with a linear guiding system for the corresponding leg 30 extending through the respective sleeve. The linear guiding system allows linear movement of the leg with respect to the corresponding sleeve 14. In its simplest form, the linear guiding system is comprised of an inner surface of the guide sleeve, which is for instance cylindrical, for guiding an outer surface of the respective leg, which may also be cylindrical. The guiding system may comprise various elements to promote movement of the legs with respect to the corresponding guide sleeve 14, such as one or more of: rollers, bearings (such as linear ball bearings), rails, or slides. One embodiment will be described below with respect to FIG. 4.

The structure 1 may be provided with a positioning system 60 allowing controlled positioning of the legs 30 with respect to the sleeves 14. Herein, an upper end of one or more of the legs 30 may be provided with a stop element 62. The corresponding sleeve 14 may be provided with a counter element 64 for catching the stop element. The stop element and/or the counter element may comprise a flange or shoulder, extending outward with respect to the respective leg or sleeve. As explained in more detail in combination with FIGS. 5A to 5E, the marine structure of the disclosure can adjust between a towing or assembly position and an operating position. In the towing position, the at least one leg 30 is moved upward through the corresponding guide sleeve 14 and wherein the stop element 62 is remote from the corresponding counter element 64. See for instance FIG. 5A. Linear motion of the legs with respect to the sleeves allows the sub-structure 3 to sink with respect to the jacket-structure 2, to the operating position. In the operating position, see for instance FIG. 1 or FIG. 5E, the stop element 62 engages a corresponding counter element 64 of the guide sleeve.

The embodiments of the present disclosure introduce loads in tangential direction into the one or more legs. Loads in radial direction are obviated, or at least significantly reduced. FIG. 4A shows the guiding system, comprising elements 72 and 74, and the positioning system 60. FIG. 4B shows the guiding system, comprising elements 72 and 74, the positioning system 60 and the breaking system 90 (elements 92, 94, 96 and 99). During lowering of the respective leg, the load transfer from sleeve to leg will run from item 72 to item 74. This load will only work in the tangential direction on the respective leg. Item 74 will further transfer the load to the respective leg 30. Thus, the capacity of the respective leg, and the guiding system, is greatly increased. The latter allows the system to handle larger loads while reducing the amount of required structural material. Item 60 will only transfer loads when the system is in the operational condition.

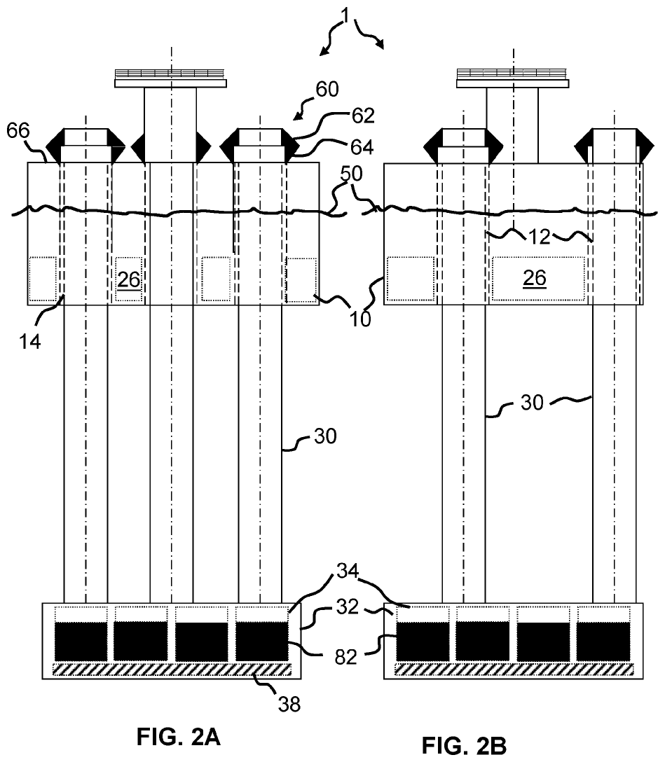

Referring to FIGS. 2A and 2B, the float element 10 may be designed to have alternative shapes and sizes. For instance, the marine structure 1 of the disclosure may comprise a single float element 10 enclosing all of the legs 30.

Optionally, the sleeves 14 may be integrated in the float element 10, as walls of the openings 12. The openings extend through the float element 10. Herein, the buoyancy chambers 26 and the related centre of buoyancy are below the waterline, and preferably below the local average wave height, when the system is in the operating condition.

The positioning system 60 may comprise the flanges or stop elements 62, 64 as described above. Alternatively or in addition, the positioning system 60 may comprise at least a stop element 62 connected to the at least one leg 30, adapted to cooperate with a top surface 66 of the at least one float element 10. Said top surface 66 may be provided with suitable strengthening or structural support to be able to provide the required counterforce. Structural support herein may include, for instance, a flange or shoulder structure.

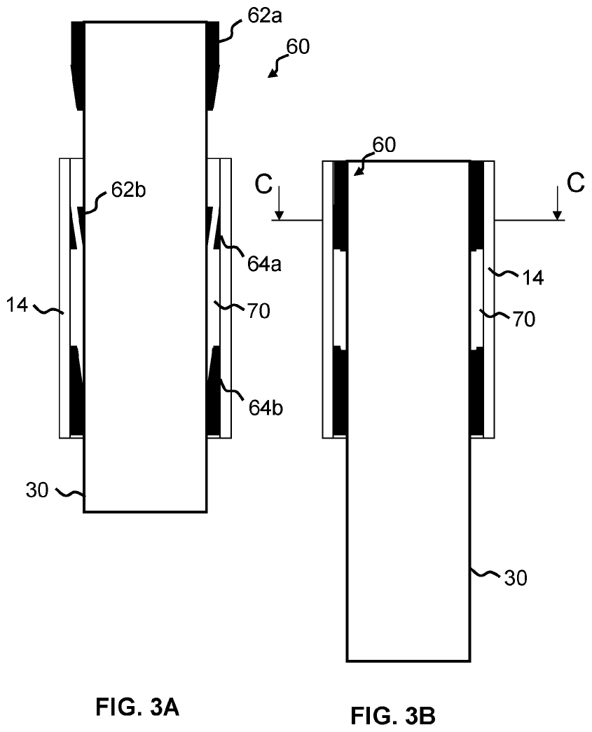

Generally referring to FIGS. 3A and 3B, the positioning system 60 may comprise sets of wedge shaped elements, such as elements 62a, 64a and 62b, 64b respectively. The stop element 62 may comprise the wedges 62a, 62b. The counter element 64 may comprise the wedges 64a, 64b. Wedge shaped structures 62a and 62b are connected to the outside of a leg 30. Opposite wedge shaped structures 64a, 64b are connected to the inside of the corresponding sleeve 14 or opening 12. The wedges are sized such that the wedges 62b and 64a can pass each other during lowering of the leg 30. In the operating position, as shown in FIG. 3B, the set of wedges, such as wedges 62a and 64a, and wedges 62b and 64b, will engage and lock into each other to form a connection between leg 30 and the sleeve 14. Respective forces on the surfaces of the wedge shaped elements can be such, that the connection between the respective wedges of each set form a bond. Said bond may be referred to as a cold weld. Although in theory the cold weld can disengage, in practice the forces between opposite parts of each set result in a durable and long-lasting bond. Said forces result from the gravitational force of the sub-structure 3 due to the weighed counterweight 32. The wedge shaped elements may comprise a suitable material, such as durable rubber material such as EPDM or a similar relatively hard elastomer, or steel.

FIG. 4A shows an exemplary embodiment of a linear guide system included in the sleeves 14. Herein, the sleeve 14 or the leg 30 may be provided with one or more rails 72. The rails 72 may extend in longitudinal direction along at least a part of the surface of the respective sleeve or leg. The other part, i.e. the leg or the sleeve, may be provided with one or more nooks or protrusions 74. The rails 72 guide and direct movement of the nooks 74. As a result, movement of the nooks, and the part such as the leg it is attached to, is limited to a linear motion in longitudinal direction. Rotation is prevented by the rails 72.

In an embodiment, the linear guide system shown in FIG. 4A may have an alternative setup. For instance, item 74 shown in FIG. 4A may be a rail. Item 72 may be protrusions, slides, or rails, able to slide along an outside of the rails 74.

One or more of the legs and/or sleeves may be provided with a guide system as exemplified in FIG. 4A. Typically, all sleeves may be provided with a guide system. Said leg and sleeve may be provided with a number of guide systems dispersed along the circumference of the leg or sleeve. Multiple positioning systems 60 may likewise be arranged distributed over the circumference of the leg or sleeve. Although any number of guide systems and/or positioning systems is conceivable, in a practical embodiment in the order of two to four positioning systems and guide systems may be provided per leg or sleeve.

Generally referring to FIG. 4B, a braking device 90 may be provided to provide a braking force between the leg(s) 30 and the sleeve(s) 14. With this braking device 90 relative movement between leg(s) 30 and the sleeve(s) 14 can be stopped or controlled more accurately. For instance, during transport of the marine structure 1 towards the installation location, it may be desirable that no movement is possible between the one or more legs 30 and the sleeves 14.

In an embodiment, the brake device 90 may comprise, for instance, one or more of a brake pad 92, a plunger 94, a hydraulic cylinder 96, a hydraulic pressure line 98, and a hydraulic pressure pump 99. The brake pad 92 may include a rubber pad. The rubber may be a relatively robust rubber, such as EPDM. The pump may be connected to a control device (not shown) to control the braking force provided by the braking device 90. Alternatives are also possible, including but not limited to, an electromagnet to drive the brake pad 92; or a mechanical brake using levers to control a brake pad. Multiple braking devices 90 may be provided. The braking devices 90 may be arranged divided along the circumference of the passage 70. All braking devices may be controlled by the same control device and pump 99. See FIG. 4B.

The braking device 90 may be included in any of the embodiments disclosed herein, and as described herein above and below. FIG. 5A shows the structure 1 of the disclosure arranged in a body of water 50. A top side structure, such as a wind turbine 80 for power generation, may be arranged on the platform 22. The wind turbine 80 may be referred to as a Wind Turbine Generator (WTG). The sub-structure 3 is moved upward with respect to the jacket-structure 2. Ultimately, upward movement of the sub-structure may be limited by an upper surface of the base 32 engaging a lower surface of the at least one float element 10. The ballast tanks 34 of the counterweight structure 32 may have been fully filled with a gas, typically air. In this position, buoyancy of the counterweight 32 with air filled tanks 34 may be sufficient to lift the entire structure 1 including the top side structure 80 above the water surface. Filling and emptying the tanks 34 with air or water may be controlled via the hose 44, pump 46 and valves 40, 42.

Buoyancy of the counterweight 32 may be adjusted by partially replacing air in the ballast tanks 34 with a material 82 heavier than air, typically water, as shown in FIG. 5B. At some point, the float elements 10 are at least partially submerged and the buoyancy of the float elements 10 starts to fully support the jacket-structure 2.

In subsequent steps, see FIGS. 5C and 5D, the buoyancy of the tanks 34 is reduced further by replacing air with a heavier material such as water. The legs 30 move downward with respect to the sleeves 14 of the jacket-structure 2.

As shown in FIG. 5D, downward movement of the base 3 with respect to the jacket-structure 2 is limited by the system 60. Buoyancy tanks 34 may be designed to be still at least partially filled with air in this position, allowing further ballasting.

While submerging the counterweight structure 32, in an embodiment, the method of the present disclosure allows to control a pressure differential over walls of the counterweight structure. Said pressure differential can be kept within a predetermined range. The pressure differential can be controlled using a pressure control system, for instance comprised of the first valve 40, the second valve 42 and the pump 46. The pressure differential over walls of the counterweight structure 32 can be kept within a range of, for instance, in the order of +/−1 bar, or about +/−0.5 bar. During the step of flooding the at least one buoyancy chamber in the counterweight structure 32, the pressure differential over the walls of the counterweight structure 32 is controlled using the pressure control system to remain within the predetermined range. In practice, the pressure differential over the walls is minimized with respect to the environment. While the counterweight structure 32 sinks in the water, the water pressure will increase. Water pressure increases with about 1 bar for every additional 10 m of depth, starting at about 1 bar at the surface. While submerging the counterweight structure, the pressure inside the buoyancy chambers of the counterweight structure is increased in accordance with the increasing water pressure. The pressure control system allows to keep the pressure inside the chambers 34 substantially equal to the water pressure outside structure 32. The pressure inside the chambers 34 may be gradually increased while the structure 32 sinks in the water. Herein, the air pressure in the chambers 34 can be increased at a rate about equal to the increase in water pressure outside the counterweight structure 32, limiting the pressure differential across the wall of the counterweight while the structure 32 is lowered to the operating position. This pressure control system allows to minimize structural strength of the walls of the counterweight structure 32, and as a result allows to save material and associated costs.

When the counterweight structure 32 will have reached the operating depth, the valves of the pressure control system can, for instance, be opened entirely, in effect evening the water pressure inside and outside of the counterweight structure 32. Alternatively, when the counterweight structure 32 will have reached the operating depth, the valves of the pressure control system can, for instance, be closed, keeping the pressure differential at a set level while allowing some air inside the buoyancy chambers to maintain the buoyancy of the counterweight structure 32 at a preferred level. As shown in FIGS. 5E and 5F, in an operating position, tanks 34 may be filled with water or other heavy material up to a level wherein the counterweight 32 has negative buoyancy and sinks. The structure 32 than acts as a counterweight, and pulls the float elements 10 down. The positive buoyancy of the float elements 10 provides a force in upward direction, whereas the weight of the ballasted counterweight 32 provides a gravitational pull in downward direction. In the operating position, shown in FIGS. 5E and 5F, the marine structure 1 behaves as a spar, providing all benefits with respect to stability resulting from a combination of a suspended counterweight and the distance thereof relative to the float elements 10. In the operating position, the centre of gravity of the marine structure 1 is located below its centre of buoyancy. The latter results in spar-like behaviour, rendering the structure inherently stable.

The positions of the marine structure 1 shown in FIGS. 5A, 5B and 5C allow to limit the draft by raising the counterweight structure 3 with respect to the jacket-structure 2. The limited draft enables placement of the top side structure 80 in relatively shallow water, such as a sheltered location, near shore or in a harbour. The buoyancy provided by the counterweight structure 3 can be changed from positive to negative. As exemplified in FIG. 5A, when the buoyancy chambers 34 are filled with air, the counterweight structure 32 may have a positive buoyancy which is sufficient to float and carry the entire marine structure 1, including the top side structure 80.

According to an embodiment of a method of the disclosure, in a first step, the draft of the structure 1 is limited to allow the structure 1 to be positioned in an assembly location of choice, typically a harbour or a near shore location. Near shore herein may refer to a location within 100 m from shore. Depending on available water depth at the assembly location, the draft may be adjusted within a range to match with available water depth, as exemplified in FIGS. 5A to 5D.

In a second step, the top side structure 80 is placed on and connected to the platform 22. Placement can be done using a land-based or floating crane, a platform, or any available lifting means.

In a third step, the marine structure including the top side structure 80 is transported to an operating location of choice. The operating location may typically be relatively far offshore. Far offshore herein may refer to a distance exceeding 500 m offshore. The operating location may have water depths exceeding 100 m, typically up to 1 km or more.

Transportation may include towing or pushing the marine structure, including the wind turbine generator 80 in its upright position, to the operating location. During transport, the draft of the marine structure can be adjusted, for instance using pump 46, as required and possible. For instance, during favourable weather conditions or transport over areas with limited water depth, the draft may be limited accordingly. During transport over areas with increased water depths, increased significant wave height, and/or during (expected) adverse weather, the draft may be increased by decreasing the buoyancy of the counterweight 32. For instance, the buoyancy of the counterweight 32 can be adjusted during transport between the positions shown in FIGS. 5A to 5D.

Thus, the counterweight-structure or sub-structure 3 can move in a substantially vertical direction with respect to the jacket-structure or support structure 2. In the towing position or transportation position (see, for instance, FIG. 5A), upward movement of the sub-structure 3 with respect to the support structure 2 is limited by the counterweight structure 32.

To limit trim and prevent toppling, stability of the marine structure 1 can be adjusted by adjusting the buoyancy of the sub-structure 3 within a given range, as exemplified in FIGS. 5B to 5D. Increasing the ballast in tanks 34 will lower the centre of gravity and increase stability while increasing draft. How, when, and by how much to adjust the buoyancy of the base 32 may depend on, for instance, weather conditions and available water depth, during transport and at the assembly location.

In an embodiment, in the operating position (FIGS. 5E, 5F), the at least one leg 30 is fixated with respect to the at least one guide sleeve 14. Fixating the leg with respect to the corresponding sleeve can be sufficiently achieved by the sets of wedges of system 60, as shown in FIG. 3B. Herein, the downward movement of the wedge parts with respect to each other during the transition from the assembly position to the operating position will result in the respective wedge parts of each set engaging each other. Due to the weight of the sub-structure, and the resulting gravitational pull on the wedge parts 62a, 62b, the engagement-as shown in FIG. 3B, in fact provides a fixed connection. The engagement in FIG. 3B may be regarded as a cold weld. Cold welding or contact welding is a solid-state welding process in which joining takes place without fusion or heating at the interface of the two parts to be welded. Unlike in fusion welding, no liquid or molten phase is present in the joint.

Alternative fixating means may be used, instead of or in addition to the sets of wedges as shown in FIG. 3. For instance, the step of fixation of the legs relative to the sleeves can comprise the insertion of one or more locking pins through corresponding openings extending through both the leg and the sleeve (not shown). Although not shown, in the example of FIG. 3B this may include a pin inserted in horizontal direction extending through both the outer and inner cylinders of sleeve and leg respectively, preventing relative movement in longitudinal direction (vertical in the figure). Hard welded connections between legs and sleeves are also possible. Fixation may be achieved by a bolted connection, involving flanges. See for instance FIG. 1A. Herein, shoulders 62 and 64 may comprise flanges, allowing a bolted connection between the respective flanges. Other alternatives are conceivable as well, such as, but not limited to, one or more of a pad-eye and pin connection; a welded connection.

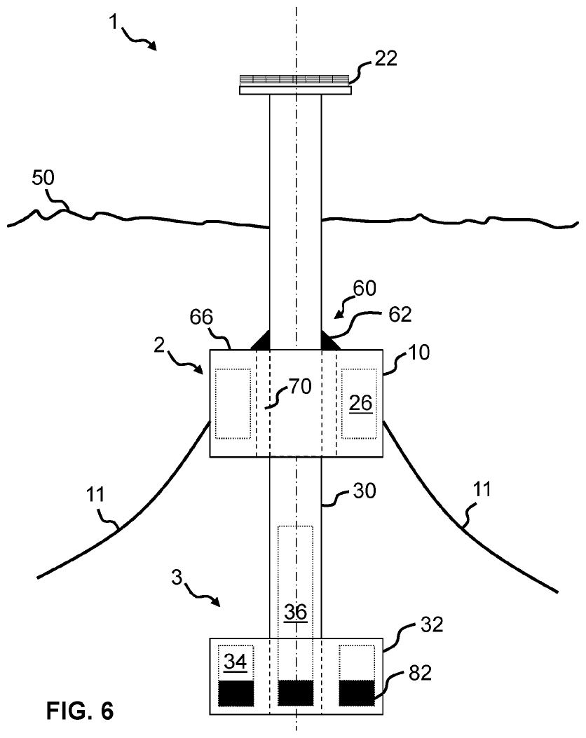

Generally referring to FIG. 6, in another embodiment the marine structure 1 may comprise a single leg 30. Herein, the platform 22 may be connected to an upper end of the single leg 30. A lower end of the leg 30 may be provide with the ballastable counterweight 32 provided with one or more buoyancy chambers 34. The buoyancy of the counterweight 32 can be adjusted by replacing air in the chambers 34 with ballast material 82 such as water.

The support structure 2 comprises a float element 10 having one or more buoyancy chambers 26. The positioning system 60 may comprise a stop element 62, such as a shoulder or flange extending radially outward from the leg 30. The stop element 62 may engage a top surface 66 of the float element 10

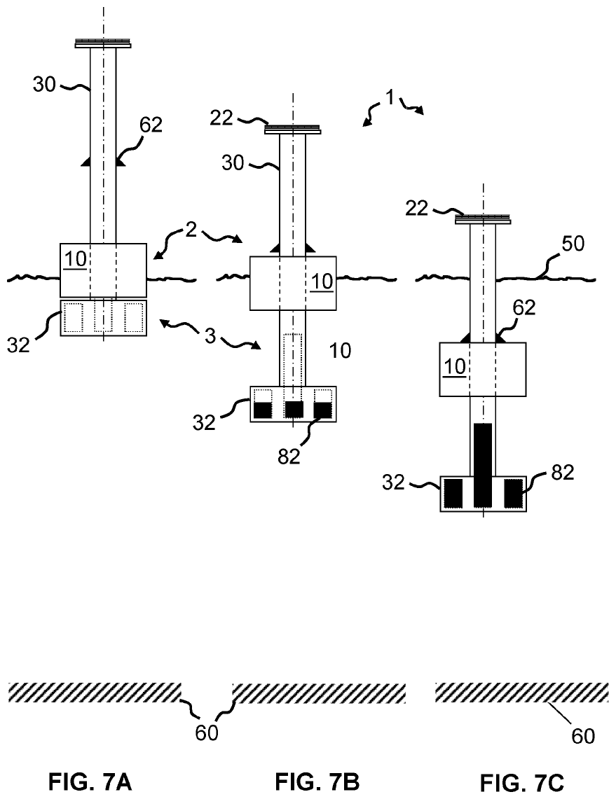

FIG. 7A shows the marine structure 1 before installation, in the transport configuration. The combined buoyancy, i.e. the first buoyancy provided by the float element 10 and the second buoyancy provided by the unballasted counterweight 32, is sufficient to keep the marine structure 1 floating in the water 50 at a shallow draft. Thus, the marine structure 1 is self-floating, i.e. no other means have to be provided to keep the marine structure 1 floating on the sea at a shallow draft.

To install the marine structure 1 to the desired configuration, in a second step shown in FIG. 7B, the sub-structure 3 of the marine structure 1 is lowered by ballasting the counterweight 32 by introducing ballast 82. Herein, the buoyancy of the float element(s) 10 is sufficient to keep the jacket-structure 2 floating in the sea at a shallow draft.

During further lowering of the base-structure 3 with respect to the jacket-structure 2, shown in FIG. 7C, the marine structure 1 is stabilized by the upward force provided by the float element 10 combined with the gravitational downward pull of the ballasted counterweight 32. The jacket-structure 2 is submerged, as shown in FIG. 7C, by ballasting the counterweight 32 so that the second buoyancy provided by the counterweight 32 becomes negative and the sub-structure 3 sinks into the water, pulling the entire marine structure downward. As the first buoyancy provided by the at least one float element 10 of the jacket-structure 2 is remained at substantially the same level, the floater 10 acts as a stabilizing element.

The sub-structure 3 is lowered in a position so that the jacket-structure 2 and sub-structure 3 are connected by means of the connection system 60. The sub-structure 3 has been moved through the passage 70 in a substantially vertical direction with respect to the jacket-structure 2.

After the Jacket-structure 2 and sub-structure 3 have been fixated with respect to each other, the buoyancy means 36 of the sub-structure 3 may be ballasted further so that the float element 10 sinks into the sea. As a result, the floater 10 may be completely submerged as shown in FIG. 7C. This position will minimise the wave action on the marine structure 1 by positioning the main buoyancy 10 carrying the marine structure 1 substantially below the wave zone, as described above.

The combination of the weight of the sub-structure 3 and its ballasted counterweight at a low position and the first buoyancy provided by the float element 10 at a high position provides a stable base for the marine structure 1 even if relative large or tall objects, such as wind turbines or cranes, are arranged on the marine structure 1.

The marine-structure 1 may completely be held on position by using anchor lines 11. In an alternative embodiment, extra measures may be provided to keep the marine structure on the desired position at the sea, for instance a propulsion system 15 as shown in FIG. 1A. The propulsion system 15 may include one or more thrusters or similar motors. The thrusters may be controlled automatically to keep the marine structure 1 at a certain location with a certain predetermined margin of error. The propulsion system may be sized such that anchor lines 11 are obviated. The propulsion system 15 can be used to counteract all the environmental loads acting on the marine system. Alternatively, such system may also or exclusively be used to dampen the horizontal and rotational motions of the marine system due to environmental variational loads or incidental loads generated by the pay-load, for instance a wind turbine or a marine crane.

The lowering procedure of the base structure is now described. FIG. 5A and 7A shows the start position and configuration denoted step 1. For this procedure the flood valve 40, the air vent valve 42, the air hose 44 and the air control system 46 may be provided for the operation. With the air control system 46 connected to the buoyancy chambers 34, through the air hose 44 and the vent valve 42, the air pressure inside the chambers 34 may be pre-set at a small overpressure. This is done to balance the pressure difference over the outside of the base 32 with the external hydrostatic pressure at the depth of the counterweight 32.

To proceed to a second step, the flood valve 40 is opened. Water will flow into the buoyancy chambers 34 and the draft of the marine structure 1 will increase. Inside the buoyancy chamber 34 the pressure will increase due to the water intake to such level that the flooding will stop when a pressure balance between outside and inside is achieved. The air cushion above the water inside the buoyancy chamber 34 is now balancing the weight of the base-structure, as shown in FIGS. 5B and 7B.

The next lowering steps, exemplified in FIGS. 5C and 5D, can be done by opening the vent valve 42 and take control of the buoyancy chamber 34 internal pressure using the air hose 44 and the air control system 46. By reducing the internal air pressure in the buoyancy chambers 34, ballast water will flow into the buoyancy chambers 34 through the at least one flood valve 40, driven by the pressure difference over the flood valve. The inflow of water will increase the weight of the sub-structure 3 and will result in a draft increase of the sub-structure. This process is reversible, by increasing the inside pressure using the air control system 46. Water can be pressed out and if so, the draft of the sub-structure will decrease accordingly.

With the pressure control system 46, See FIG. 5A, the lowering or lifting of the sub-structure 3 can be operated in a controlled and safe way without the need for complicated, expensive, and risky mechanical lifting devices conventionally used for similar operations. Another advantage of the air control system 46 is the reduced design pressure loads on the external walls, ceilings, and floors of the counterweight structure 32. This structure can be constructed from concrete or steel or a combination of the two materials. The amount of material required to resist the water pressure can be greatly reduced using the pressure control system 46 by reducing the differential pressure over the external walls, ceilings, and floors of the counterweight 32 even at depth in the water.

In a final step, see FIG. 5E or 7C, the air control system 46 and air hose 44 may be removed. In this position, the vent valve 42 and the flood valve 40 may be open to the sea. The internal and external pressures over the external walls, ceilings, and floors of the counterweight 32 are now fully balanced.

In a practical embodiment, the marine structure of the disclosure can be dimensioned to support a wind turbine generator of any suitable shape or size. For instance, the draft (i.e. the maximum depth of the structure below the surface of the water) of the marine structure in its operating position may range in the order of more than 50 m, up to 100 m or more. Thus, the structure 1 in its operating position can behave like a spar structure, providing stability and preventing toppling of the top side structure 80 due to the suspended counterweight 32.

The wind turbine generator 80 may be sized up of, for instance, a mast height of 50 to 150 m. Blades of the wind turbine generator may have a length in the order of 50 to 120 m. The power indication of the wind turbine generator may be in the order of 1 to 20 MW. The structure 1 can function as a floating foundation for wind turbines ranging from relatively small to the largest wind turbines currently envisaged.

In practice, the marine structure of the disclosure may be constructed from materials providing suitable strength, weight, buoyancy, and sufficient lifetime in offshore marine environments. Offshore, corrosion resistance may be even more important than for onshore operations. Also, the marine structure including its top side structure will, in practice, be designed to withstand storm and significant wave motion. Regarding the latter, the structure of the disclosure has the advantage of controllable draft via dedicate control vents, such as valves 42 and 40. In its operating position, see for instance FIG. 5E, the base 32 is submerged, but also the float elements 10 may be submerged. To increase stability, the float elements 10 may be submerged such that a top surface thereof is below a predetermined depth. Said predetermined depth may exceed an average wave height, RMS wave height, or significant wave height at the location of operation.

Wave height herein may be the distance between the peak of a wave to a valley. Significant wave height, scientifically represented as Hₛ or H_{sig}, is a parameter for the statistical distribution of (ocean) waves. The most common waves are lower in height than Hₛ. This implies that encountering the significant wave is not too frequent. However, statistically, it is possible to encounter a wave that is much higher than the significant wave. Generally, the statistical distribution of the individual wave heights is approximated by a Rayleigh distribution. For example, given that Hₛ is 10 metres (33 feet), statistically: 1 wave in 10 will be larger than 10.7 metres (35 ft); 1 wave in 100 will be larger than 15 metres (50 ft); and 1 wave in 1000 will be larger than 18.5 metres (61 ft). This implies that one might encounter a wave that is roughly double the significant wave height. However, in rapidly changing conditions, the disparity between the significant wave height and the largest individual waves might be even larger.

Other statistical measures of the wave height are also widely used. The root mean square (RMS) wave height, which is defined as square root of the average of the squares of all wave heights, is approximately equal to Hₛ divided by 1.4.

Significant wave height may differ per offshore location, and may be in the range of 5 to 15 m. In the book Oceanography and Seamanship, William G. Van Dorn provided an example of what the wave heights would be if a steady 30 knots (33 mph/53 km/h) wind blew for 24 hours over a fetch of 340 miles. If so, 10% of all waves will be less than 3.6 ft. (1 m). The most frequent wave height will be 8.5 ft. (2.5 m). The average wave height will be 11 ft. (3 m). The significant wave height will be 17 ft. (5 m). 10% of all waves will be higher than 18 ft. (5 m). The average wave height of the highest 10% of all waves will be 22 ft. (7 m). A 5% chance of encountering a single wave higher than 35 ft. (11 m) among every 200 waves that pass in about 30 minutes. A 5% chance of encountering a single wave higher than 40 ft. (12 m) among every 2,600 waves that pass in about five hours.

In a practical embodiment, the marine structure of the disclosure can be dimensioned and designed to withstand significant wave height in the order of 10 to 17 m. Please note that Hₛ of 17 m is the highest significant wave height for design restrictions. A system suitable to withstand Hₛ of 17 m is the most severe design restriction. The latter will render the marine structure of the disclosure suitable for unrestricted worldwide operation.

The structure 1 may be designed such that, when in the operating position, the float elements 10 are submerged more than at least once or twice the wave height at the location of operation. Herein, wave height may be selected from significant wave height, RMS wave height, or average wave height. Alternatively, buoyancy of the float elements 10 of the structure 1 may be reduced in periods of expected adverse weather conditions, to increase the stability and submerge the float elements 10 more.

In a practical embodiment, the marine structure of the disclosure can be constructed using steel and concrete. For instance the support structure 2 can be made of steel. The base structure 3 including the legs 30 may be made of concrete, wherein the concrete is potentially reinforced using steel wire mesh.

As an example, the wind turbine 80 may have a mast height in the order of 100 to 150 m. The blades of the wind turbine 80 may have a length in the order of 70 to 95% of the mast height, or for instance in the order of 80 to 125 m. The base 32 in the operation position may have a draft of about 50 to 100 m, for instance about 60 to 70 m. The bottom side of the float elements 10 may be submerged about 10 to 25 m while in the operating position, for instance about 15 to 20 m. The latter may be referred to as the draft of the jacket or the draft of the support structure 2. A top surface of the float elements 10 may be submerged about 5 to 10 m below the surface of the water. The top of the support structure 2 may extend about 10 to 20 m above the surface of the water. The counterweight 32 may be substantially round or donut-shaped. The counterweight structure 32 may have a diameter in the order of 40 to 75 m, for instance about 50 to 60 m. The counterweight structure 32 may have a height in the order of 5 to 20 m, for instance about 10 to 15 m. The structure may comprise about three float elements 10. The float elements 10 may be substantially round. The float elements 10 may have a diameter in the order of 10 to 40 m, for instance about 20 to 30 m, for instance about 25 m. The legs 30 may have a diameter in the order of 5 to 15 m, for instance about 7 to 10 m. These sizes are exemplary only, and may in practice either be larger or smaller. The dimensions in practice may depend on the operating location, the assembly location, local significant wave height, average weather conditions, wind turbine dimensions, etc., the structure of the disclosure may be sized in accordance.

With reference to, for instance, FIG. 1B, in a preferred embodiment, the jacket-structure 2 and sub-structure 3 may be designed such that, in top view, the centre of gravity and the centre of buoyancy are located in the middle, i.e. on the centre line. Alternatively, the centre of gravity and/or centre of buoyancy may be eccentric.

The marine structure 1 of the present disclosure may also be used as a floating base for other suitable applications, such as an offshore platform, a work platform, a solar power installation, a wave energy converter, a hydrogen storage and/or conversion unit or a meteo mast. Alternatively, the structure may be used for a multi-use application combining any of the mentioned applications, for instance wind turbine and wave energy converter combined on one marine structure 1 as disclosed herein.

The marine structure 1 of the present disclosure may also be used as a wave energy converter, typically at an operation position as shown in FIG. 5C. The relative vertical motion between the leg(s) 30 and the sleeve(s) 14 can be used to generate electrical power using some type of converter to transfer mechanical energy (of the legs 30 moving with respect to the jacket structure 2 due to waves) to electrical energy. Thus, when used as a wave energy converter, the legs will be able to move with respect to the jacket structure, and will not be fixated.

The marine structure 1 of the present disclosure may also be used as multi-use power station by combining for instance three electricity generation methods, such as solar, wave and wind, with a hydrogen energy conversion and storage application. Thus, the system will typically produce a more constant electrical power output (called peak shaving) to end users. The latter may significantly increase the efficiency of the installation.

The scope of the present disclosure is not limited to the embodiments described above. Many modifications therein are conceivable without deviating from the scope of the present invention as defined by the appended claims. In particular, combinations of features of respective embodiments or aspects of the disclosure can be made. An aspect of the invention may be further advantageously enhanced by adding a feature that was described in relation to another aspect of the invention. While the present invention has been illustrated and described in detail with reference to the figures, such illustration and description are illustrative or exemplary only.

In the claims, the word “comprising” does not exclude other steps or elements, and “a” or “an” does not exclude a plurality. The mere fact that certain measures are recited in mutually different dependent claims does not indicate that a combination of these measures cannot be used to advantage. Any reference numerals in the claims should not be construed as limiting the scope of the present invention.

1. A marine structure, comprising:
a jacket-structure for supporting a functional element in a body of water, the jacket-structure comprising at least one float element having a first buoyancy, and at least one linear guide sleeve;
a sub-structure comprising a counterweight structure having a second buoyancy and at least one leg extending through the at least one guide sleeve, the at least one leg having a lower end connected to the counterweight structure and having an upper end provided with a stop element,
wherein the at least one leg is movable through the corresponding guide sleeve between a towing position, wherein the stop element is remote from the guide sleeve and wherein the guide sleeve allows linear motion of the at least one leg with respect to the support structure, and an operating position, wherein the stop element engages a corresponding counter element of the guide sleeve and wherein the at least one leg is fixated with respect to the at least one guide sleeve.

2. The marine structure of claim 1, wherein the jacket-structure comprising a fixating mechanism to fixate the at least one leg with respect to the support structure when in the operating position.

3. The marine structure of claim 2, wherein the fixating mechanism comprising one or more sets of wedges, one wedge part of each set of wedges being connected to an outer surface of the at least one leg, and a second wedge part of each set of wedges being connected to an inner surface of a corresponding guide sleeve.

4. The marine structure of claim 1, further comprising a linear guiding system, integrated in the at least one guide sleeve.

5. The marine structure of claim 4, wherein the linear guiding system further comprising ridges distributed along the circumference of the at least one guide sleeve, and corresponding nooks fitting between two ridges and extending from an outer surface of the at least one leg.

6. The marine structure of claim 1, wherein the counterweight structure has an adjustable weight, said weight providing buoyancy when in the towing position and said weight weighing the marine structure down when in the operating position.

7. The marine structure of claim 1, wherein the functional element includes a wind turbine.

8. The marine structure of claim 1, wherein the counterweight structure encloses the lower end of the at least one leg.

9. The marine structure of claim 1, wherein the at least one guide sleeve is provided with a brake to limit movement of the at least one leg with respect to the corresponding at least one guide sleeve.

10. The marine structure of claim 1, further comprising multiple legs, each leg being enclosed by the at least one float element.

11. The marine structure of claim 1, wherein the first buoyancy exceeds a gravitational force of the rest of the marine structure including the weighed counterweight structure when in the operating position, keeping the marine structure afloat.

12. The marine structure of claim 1, further comprising at least one thruster for positioning the marine structure in the water.

13. The marine structure of claim 1, wherein the counterweight structure being provided with a first valve for passage of water, and a second valve connected to a pump for pumping gas in or out of the counterweight structure.

14. The marine structure of claim 13, wherein the pump being located above the water surface and being connected to the second valve via a conduit allowing to pump air into or out of the counterweight structure.

15. The marine structure of claim 14, wherein the pump and the conduit being removable to allow removal of the pump and conduit when the marine structure is in the operating position.

16. A method to install a marine structure, comprising the steps of:
providing a marine structure comprising:
a jacket-structure for supporting a functional element in a body of water, the support structure comprising at least one float element having a first buoyancy, and at least one linear guide sleeve;
a sub-structure comprising a counterweight structure having a second buoyancy and at least one leg extending through the at least one guide sleeve, the at least one leg having a lower end connected to the counterweight structure and having an upper end provided with a stop element,
wherein the at least one leg is movable through the corresponding guide sleeve between a towing position, wherein the stop element is remote from the guide sleeve and wherein the guide sleeve allows linear motion of the at least one leg with respect to the support structure, and an operating position, wherein the stop element engages a corresponding counter element of the guide sleeve and wherein the at least one leg is fixated with respect to the at least one guide sleeve,
the method comprising the steps of:
moving the at least one leg to the towing position by decreasing the weight of the counterweight structure,
moving the marine structure to an assembly position near shore,
arranging the structural element on the support structure,
towing the marine structure to a predetermined offshore location, and
increasing the weight of the counterweight structure, thereby moving the at least one leg downward to the operating position until the stop element engages the corresponding counter element of the at least one guide sleeve and submerging the at least one float element, and
fixating the at least one leg with respect to the at least one guide sleeve.

17. The method of claim 16, further comprising the step of anchoring the floating marine structure to the bottom of the body of water using one or more anchoring lines.

18. The method of claim 16, wherein in the operating position the counterweight structure floats below a wave zone.

19. The method of claim 16, wherein in the operating position, the weight of the counterweight structure is increased to submerge the at least one float element.

20. The method of claim 19, wherein the float element is submerged entirely at least below an average wave height at the predetermined offshore location.

21. The method of claim 16, wherein the step of increasing the weight of the counterweight structure comprises flooding at least one buoyancy chamber in the counterweight structure using a first valve for passage of water, and a second valve connected to a pump for pumping gas into or out of the counterweight structure.

22. The method of claim 21, wherein the step of flooding the at least one buoyancy chamber in the counterweight structure comprises controlling a pressure differential over walls of the counterweight structure to remain within a predetermined range.

23. The method of claim 22, the predetermined range being +/−1 bar, more preferably +/−0.5 bar.
